(19) United States
(12) Patent Application Publication
(10) Pub. No.: US 2001/0034669 A1
(43) Pub. Date: Oct. 25, 2001

(54) System and method for permitting a potential purchaser to review at least part of the subject matter of a document without being informed of the document's source

(76) Inventor: Matthew Bruce Tropper, Plainview, NY (US)

Correspondence Address: Matthew B. Tropper, 30 Southern Parkway, Plainview, NY, 11803, US

(21) Appl. No.: 09/788,936

(22) Filed: Feb. 20, 2001

Related U.S. Application Data
(60) Provisional application No. 60/184,135, filed on Feb. 22, 2000.

(51) Int. Cl. G06F 17/60

(52) U.S. Cl. 705/27

(57) ABSTRACT

A system and method for permitting a potential purchaser to review at least part of the subject matter of a document without being informed of the document's bibliographic data (that is, the document's source-identifying data) and for assuring payment to a seller if the potential purchaser chooses to purchase the bibliographic data and/or a copy of the original version of the document.

CROSS-REFERENCE TO RELATED APPLICATIONS

This application claims the benefit under 35 U.S.C. 119(e) of U.S. Provisional Application Ser. No. 60/184,135, filed Feb. 22, 2000.

### BACKGROUND OF THE INVENTION

1. Field of the Invention

The instant invention relates to a system and method for permitting a potential purchaser to review at least part of the subject matter of a document without being informed of the document's bibliographic data (that is, the document's source-identifying data) and for assuring payment to a seller if the potential purchaser chooses to purchase the document's bibliographic data and/or a copy of an original version of the document.

More particularly, the instant invention relates to a system and method for permitting a potential purchaser to review at least part of the subject matter of a document potentially having a bearing on the validity of a patent without being informed of the document's bibliographic data (that is, the document's source-identifying data) and for assuring payment to a seller if the potential purchaser chooses to purchase the document's bibliographic data and/or a copy of an original version of the document.

The instant invention may be used as an aid in determining the validity of a patent in connection with litigation or due diligence investigation involving acquisition of the patent by helping to identify references which disclose the subject matter claimed in the patent and which pre-date the patent by a sufficient length of time to be applied as prior art under the applicable laws and regulations.

2. Description of the Related Art

### Factors Affecting Patent Validity

The validity of a potentially invalid patent depends upon many factors. A major source of patent invalidity is the existence of an earlier document, such as another patent or a published article, which renders unpatentable the subject matter claimed in the potentially invalid patent.

It is noted that when arguing that such an earlier document invalidates a potentially invalid patent a party is in a much stronger position if the earlier document was not before the Patent Examiner who examined the application maturing into the potentially invalid patent (such documents that were before the Patent Examiner are identified in a patent under a heading such as References Cited). In other words, there is a presumption that such an earlier document that was before the Patent Examiner does not render unpatentable what is claimed in the potentially invalid patent. In contrast, there is no such presumption attached to earlier documents that were not before the Patent Examiner who examined the application maturing into the potentially invalid patent.

In any case, patent validity determinations rely greatly upon searching for earlier documents which may invalidate the potentially invalid patent, particularly earlier documents that were not before the Patent Examiner who examined the application maturing into the potentially invalid patent. Such earlier documents which can invalidate the potentially invalid patent shall hereafter be referred to as “Invalidating Prior Art”.

### Conventional Means For Identifying Invalidating Prior Art

One prior art method of finding Invalidating Prior Art involves performing a computer search of a patent database. Such patent databases are maintained by government organizations such as the U.S. Patent and Trademark Office (“USPTO”), as well as by commercial organizations. In any case, a party seeking to determine the validity of a patent will search an appropriate patent database in an effort to find Invalidating Prior Art.

FIG. 1 shows a conventional system for searching the USPTO Patent Database. As seen in this FIG. 1, the USPTO Patent Database 101 is made available to the public through the U.S. Patent and Trademark Office Internet Website (“USPTO Website”) 103. The USPTO Website is currently found at “http://www.uspto.gov”. Searches of the USPTO Patent Database 101 are performed by using a Web Browser 104 (such as Microsoft Corporation's Internet Explorer or Netscape Communications Corporation's Navigator) to enter search criteria into a Database Search Engine 105 associated with the USPTO Website 103 and the USPTO Patent Database 101 via the Internet 106 and to view the results of the search returned by the Database Search Engine 105. The search criteria are generally chosen to find patents containing particular “keywords”. After the search results are returned various “hyperlinks” to other documents within the USPTO Patent Database 101 may be followed individually, by manually selecting them one at a time using Web Browser 104. Searches of similar patent databases such as, for example, the IBM Intellectual Property Network patent database available at “http://www.patents.ibm.com/home” are carried out in a similar manner.

A significant disadvantage of searching the various patent databases as described above is that the search is limited to patents, the same type of documents searched by the Examiner of the potentially invalid patent in the first place. In other words, there is a high probability that any patents found during this type of search have already been identified by the Examiner of the potentially invalid patent as irrelevant or have been cited in the potentially invalid patent. Further, even if the patent database contains Invalidating Prior Art the Invalidating Prior Art may not be found if the “keywords” chosen for the search are not found within the Invalidating Prior Art. Moreover, this type of search obviously does not identify any of the vast number of non-patent publications which may in fact be Invalidating Prior Art.

Another prior art method of finding Invalidating Prior Art involves performing a computer search of one or more databases of published literature, such as magazine, newspaper, and journal articles. Such databases are maintained by various government, commercial, an non-profit organizations such as the DIALOG database at “http://dialog.com” and the SOFTWARE PATENT INSTITUTE literature database found at “http://www.spi.org/”, for example. In any case, a party seeking to determine the validity of a patent will often search an appropriate literature database in a manner similar to that used to search the USPTO Patent Database described above in an effort to find Invalidating Prior Art.

More particularly, as seen in FIG. 2, a Literature Database 201 is made available to the public (either for a fee or for free) through a Literature Database Website 203. Searches of the Literature Database 201 are performed by using a Web Browser 204 (such as Microsoft Corporation's Internet Explorer or Netscape Communications Corporation's Navigator) to enter search criteria into a Database Search Engine 205 associated with the Literature Database Website 203 and the Literature Database 201 via the Internet 206 and to view the results of the search returned by the Database Search Engine 205. The search criteria are generally chosen to find documents containing particular “keywords”.

A significant disadvantage of this method is that the search is time consuming, expensive (in the case of commercial databases), and not all-inclusive. Since no one database exists which includes all published literature multiple databases must be searched in an attempt to find Invalidating Prior Art. Such multiple searches are obviously time-consuming. Moreover, many of the commercial computer databases containing published literature are very expensive to access, and the more of these databases that are searched the higher the total cost. Further, it is a practical impossibility to search all such databases and the result is that a publication that is in fact Invalidating Prior Art may not be found if it is contained within a database that is not searched. Further still, even if a particular database is searched which contains Invalidating Prior Art the Invalidating Prior Art may not be found if the “keywords” chosen for the search are not found within the Invalidating Prior Art.

### OBJECTS AND SUMMARY OF THE INVENTION

It is therefore an object of the instant invention to provide a system and method for finding Invalidating Prior Art which overcomes the disadvantages of the conventional search techniques. It is another object of the instant invention to provide a system and method for finding Invalidating Prior Art which overcomes the disadvantages of the conventional search techniques related to searching in one or more computer databases.

It is another object of the instant invention to provide a system and method for finding Invalidating Prior Art which overcomes the disadvantages of the conventional search techniques related to searching computer databases for using “keywords”.

It is another object of the instant invention to provide a system and method for aiding in determining the validity of a patent in connection with litigation or due diligence investigation involving acquisition of the patent by helping to identify references which disclose the subject matter claimed in the patent and which pre-date the patent by a sufficient length of time to be applied as prior art under the applicable laws and regulations.

It is another object of the instant invention to provide a system and method for permitting a potential purchaser to review at least part of the subject matter of a document without being informed of the document's bibliographic data (that is, the document's source-identifying data) and for assuring payment to a seller if the potential purchaser chooses to purchase the document's bibliographic data and/or a copy of an original version of the document.

It is another object of the instant invention to provide a system and method for permitting a potential purchaser to review at least part of the subject matter of a document potentially having a bearing on the validity of a patent without being informed of the document's bibliographic data (that is, the document's source-identifying data) and for assuring payment to a seller if the potential purchaser chooses to purchase the document's bibliographic data and/or a copy of an original version of the document.

It is another object of the instant invention to provide a system and method for facilitating commerce by promoting the exchange of bibliographic data and/or original version documents in a manner which encourages members of the public to submit such bibliographic data and/or original version documents for sale into a centralized repository in return for the assurance of being paid if a purchaser chooses to purchase the bibliographic data and/or original version documents after review of at least a part of the subject matter of the original version documents.

It is another object of the instant invention to provide a system and method for facilitating commerce by promoting the exchange of bibliographic data and/or original version documents in a manner which encourages purchasers of such bibliographic data and/or original version documents to submit purchase criteria into a centralized repository in return for the benefit of being able to review at least a part of the subject matter of the original version documents submitted by potential sellers in order to determine the suitability of the documents for a particular purpose before purchasing the bibliographic data and/or original version documents.

Other objects and advantages will become apparent from the detailed description, claims, and accompanying drawings.

### BRIEF DESCRIPTION OF THE DRAWINGS

FIG. 1 shows a block diagram of a system for identifying patents in a database according to the prior art;

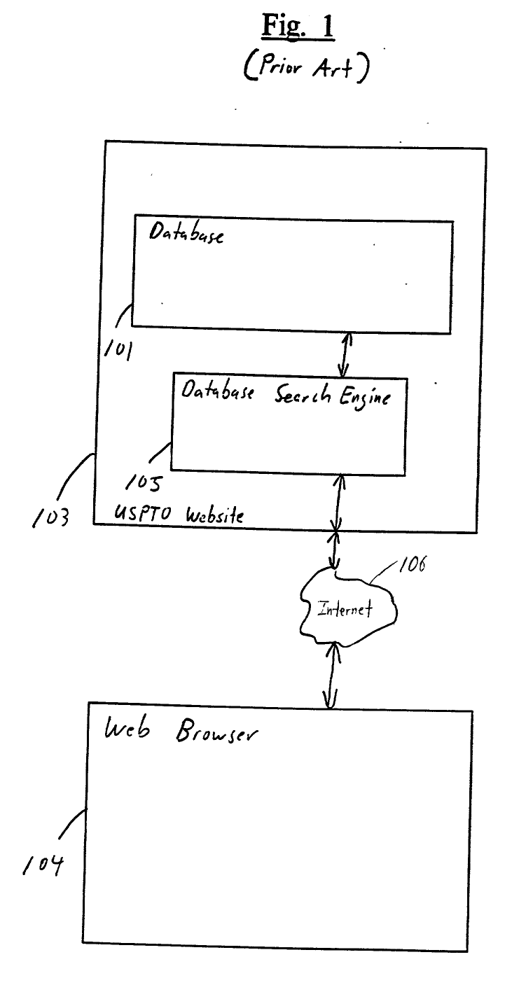

FIG. 2 shows a block diagram of another system for identifying patents in a database according to the prior art;

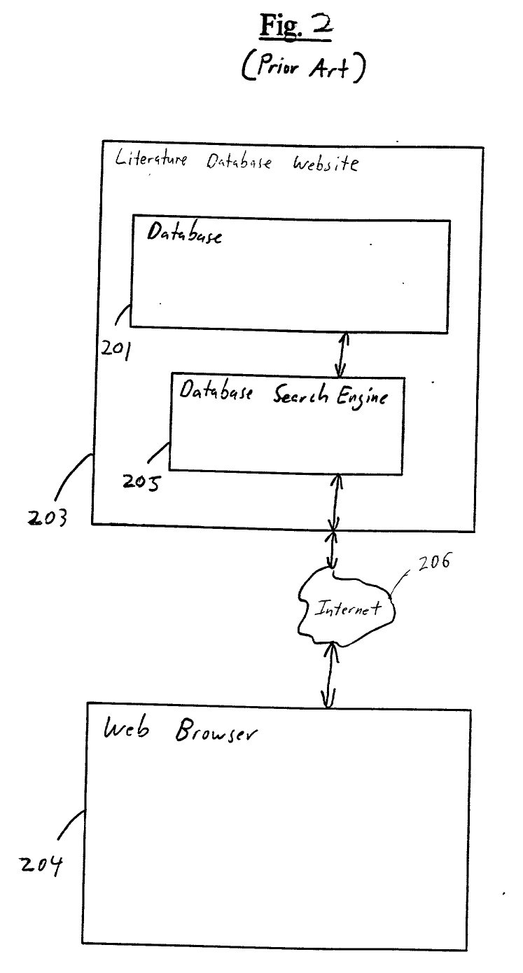

FIG. 3 shows a block diagram of a first embodiment of the instant invention;

FIG. 4 shows part of the operation of the first embodiment of the instant invention;

FIG. 5 shows part of the operation of the first embodiment of the instant invention;

FIG. 6 shows part of the operation of the first embodiment of the instant invention; and

FIG. 7 shows a block diagram of a second embodiment of the instant invention.

### DETAILED DESCRIPTION OF THE PREFERRED EMBODIMENTS

A system for permitting a potential purchaser to review at least part of the subject matter of a document without being informed of the document's bibliographic data and for assuring payment to a seller if the potential purchaser chooses to purchase at least one of the document's bibliographic data and an original version of the document is provided, comprising: means for receiving from the potential seller at least one of the document's bibliographic data and an original version of the document; means for obtaining an original version of the document if not received from the potential seller; means for generating a new version of the document which does not contain the document's bibliographic data and which does contain at least part of the subject matter of the original version of the document; means for providing the new version of the document to the potential purchaser; means for obtaining from the potential purchaser an obligation to pay a purchase price if the potential purchaser chooses to purchase at least one of the document's bibliographic data and an original version of the document; and means for providing at least one of the document's bibliographic data and an original version of the document to the potential purchaser if the potential purchaser chooses to purchase at least one of the document's bibliographic data and an original version of the document.

Another system for permitting a potential purchaser to review at least part of the subject matter of a document which potentially has a bearing on a patent under test without being informed of the document's bibliographic data and for assuring payment to a seller if the potential purchaser chooses to purchase at least one of the document's bibliographic data and an original version of the document is provided, comprising: means for providing to the potential seller data identifying the patent under test; means for receiving from the potential seller at least one of the document's bibliographic data and an original version of the document; means for obtaining an original version of the document if not received from the potential seller; means for generating a new version of the document which does not contain the document's bibliographic data and which does contain at least part of the subject matter of the document; means for providing the new version of the document to the potential purchaser; means for obtaining from the potential purchaser an obligation to pay a purchase price if the purchaser chooses to purchase at least one of the document's bibliographic data and an original version of the document; and means for providing at least one of the document's bibliographic data and an original version of the document to the potential purchaser if the potential purchaser chooses to purchase at least one of the document's bibliographic data and an original version of the document.

Means for providing the new version of the document to the potential purchaser may further comprise means for providing the new version of the document to the potential purchaser in electronic form. Means for providing the new version of the document to the potential purchaser in electronic form may further comprise means for providing the new version of the document to the potential purchaser via an internet web page.

Means for providing at least one of the document's bibliographic data and an original version of the document to the potential purchaser if the potential purchaser chooses to purchase at least one of the document's bibliographic data and an original version of the document may further comprise means for providing at least one of the document's bibliographic data and an original version of the document to the potential purchaser in electronic form. Means for providing at least one of the document's bibliographic data and an original version of the document to the potential purchaser in electronic form may further comprise means for providing at least one of the document's bibliographic data and an original version of the document to the potential purchaser via an internet web page.

Means for providing to the potential seller data identifying the patent under test may further comprise means for providing to the potential seller data in an electronic format identifying the patent under test. Means for providing to the potential seller data in an electronic format identifying the patent under test may further comprise means for providing to the potential seller data via an internet web page identifying the patent under test.

The system may further comprise means for providing to the potential seller data identifying a date by which a document must have been published, or in the case of a patent issued or effectively filed, in order to be applied against the patent under test as prior art. Means for providing to the potential seller data identifying a date by which a document must have been published, or in the case of a patent issued or effectively filed, in order to be applied against the patent under test as prior art may comprise means for providing to the potential seller data in an electronic form identifying a date by which a document must have been published, or in the case of a patent issued or effectively filed, in order to be applied against the patent under test as prior art. Means for providing to the potential seller data in an electronic form identifying a date by which a document must have been published, or in the case of a patent issued or effectively filed, in order to be applied against the patent under test as prior art may comprise means for providing to the potential seller data via an internet web page identifying a date by which a document must have been published, or in the case of a patent issued or effectively filed, in order to be applied against the patent under test as prior art.

The system may further comprise means for providing to the potential purchaser data selected from the group consisting of (a) a date before which the document was published; (b) a country in which the document was published; and (c) the type of publication in which the document was published. Means for providing to the potential purchaser data selected from the group consisting of (a) a date before which the document was published; (b) a country in which the document was published; and (c) the type of publication in which the document was published may further comprise means for providing to the potential purchaser data in an electronic form selected from the group consisting of (a) a date before which the document was published; (b) a country in which the document was published; and (c) the type of publication in which the document was published. Means for providing to the potential purchaser data in an electronic form selected from the group consisting of (a) a date before which the document was published; (b) a country in which the document was published; and (c) the type of publication in which the document was published may further comprise means for providing to the potential purchaser data via a web page on the internet selected from the group consisting of (a) a date before which the document was published; (b) a country in which the document was published; and (c) the type of publication in which the document was published.

The system may further comprise means for carrying out a purchase transaction electronically and securely using a protocol selected from the group comprising: a) a credit card authorization, b) a debit card transfer, and c) another form of electronic payment.

A method for permitting a potential purchaser to review at least part of the subject matter of a document without being informed of the document's bibliographic data and for assuring payment to a seller if the potential purchaser chooses to purchase at least one of the document's bibliographic data and an original version of the document is provided, comprising: receiving from the potential seller at least one of the document's bibliographic data and an original version of the document; obtaining an original version of the document if not received from the potential seller; generating a new version of the document which does not contain the document's bibliographic data and which does contain at least part of the subject matter of the original version of the document; providing the new version of the document to the potential purchaser; obtaining from the potential purchaser an obligation to pay a purchase price if the potential purchaser chooses to purchase at least one of the document's bibliographic data and an original version of the document; and providing at least one of the document's bibliographic data and an original version of the document to the potential purchaser if the potential purchaser chooses to purchase at least one of the document's bibliographic data and an original version of the document.

Another method for permitting a potential purchaser to review at least part of the subject matter of a document which potentially has a bearing on a patent under test without being informed of the document's bibliographic data and for assuring payment to a seller if the potential purchaser chooses to purchase at least one of the document's bibliographic data and an original version of the document is provided, comprising: providing to the potential seller data identifying the patent under test; receiving from the potential seller at least one of the document's bibliographic data and an original version of the document; obtaining an original version of the document if not received from the potential seller; generating a new version of the document which does not contain the document's bibliographic data and which does contain at least part of the subject matter of the document; providing the new version of the document to the potential purchaser; obtaining from the potential purchaser an obligation to pay a purchase price if the purchaser chooses to purchase at least one of the document's bibliographic data and an original version of the document; and providing at least one of the document's bibliographic data and an original version of the document to the potential purchaser if the potential purchaser chooses to purchase at least one of the document's bibliographic data and an original version of the document.

The step of providing the new version of the document to the potential purchaser may further comprise providing the new version of the document to the potential purchaser in electronic form. The step of providing the new version of the document to the potential purchaser in electronic form may further comprise providing the new version of the document to the potential purchaser via an internet web page.

The step of providing at least one of the document's bibliographic data and an original version of the document to the potential purchaser if the potential purchaser chooses to purchase at least one of the document's bibliographic data and an original version of the document may further comprise providing at least one of the document's bibliographic data and an original version of the document to the potential purchaser in electronic form. The step of providing at least one of the document's bibliographic data and an original version of the document to the potential purchaser in electronic form may further comprise providing at least one of the document's bibliographic data and an original version of the document to the potential purchaser via an internet web page.

The step of providing to the potential seller data identifying the patent under test may further comprise providing to the potential seller data in an electronic format identifying the patent under test. The step of providing to the potential seller data in an electronic format identifying the patent under test may further comprise providing to the potential seller data via an internet web page identifying the patent under test.

The method may further comprise providing to the potential seller data identifying a date by which a document must have been published, or in the case of a patent issued or effectively filed, in order to be applied against the patent under test as prior art. The step of providing to the potential seller data identifying a date by which a document must have been published, or in the case of a patent issued or effectively filed, in order to be applied against the patent under test as prior art may comprise providing to the potential seller data in an electronic form identifying a date by which a document must have been published, or in the case of a patent issued or effectively filed, in order to be applied against the patent under test as prior art. The step of providing to the potential seller data in an electronic form identifying a date by which a document must have been published, or in the case of a patent issued or effectively filed, in order to be applied against the patent under test as prior art may comprise providing to the potential seller data via an internet web page identifying a date by which a document must have been published, or in the case of a patent issued or effectively filed, in order to be applied against the patent under test as prior art.

The method may further comprise the step of providing to the potential purchaser data selected from the group consisting of (a) a date before which the document was published; (b) a country in which the document was published; and (c) the type of publication in which the document was published. The step of providing to the potential purchaser data selected from the group consisting of (a) a date before which the document was published; (b) a country in which the document was published; and (c) the type of publication in which the document was published may further comprise providing to the potential purchaser data in an electronic form selected from the group consisting of (a) a date before which the document was published; (b) a country in which the document was published; and (c) the type of publication in which the document was published. The step of providing to the potential purchaser data in an electronic form selected from the group consisting of (a) a date before which the document was published; (b) a country in which the document was published; and (c) the type of publication in which the document was published may further comprise providing to the potential purchaser data via a web page on the internet selected from the group consisting of (a) a date before which the document was published; (b) a country in which the document was published; and (c) the type of publication in which the document was published.

The method may further comprise carrying out a purchase transaction electronically and securely using a protocol selected from the group comprising: a) a credit card authorization, b) a debit card transfer, and c) another form of electronic payment.

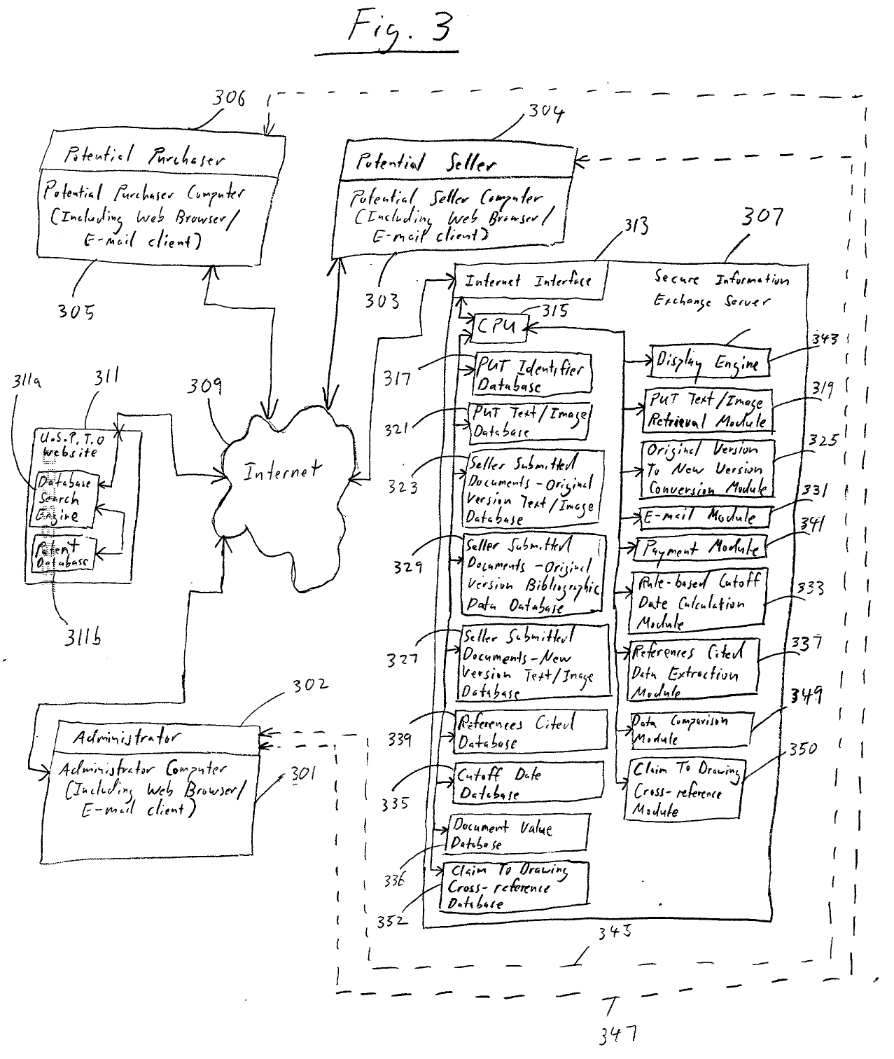

Referring now to FIG. 3, a first embodiment of the instant invention is shown. As seen in this FIG. 3, Administrator Computer 301 (operated by Administrator 302), Potential Seller Computer 303 (operated by Potential Seller 304), and Potential Purchaser Computer 305 (operated by Potential Purchaser 306) are each connected to Secure Information Exchange Server 307 via the Internet 309. While this FIG. 3 shows one Potential Seller and one Potential Buyer there can, of course, be any desired number of Potential Seller(s) and Potential Buyer(s). Secure Information Exchange Server 307 is also connected to USPTO Website 311 as desired. USPTO Website 311 includes Database Search Engine 311a and Patent Database 311b. The interconnection of Secure Information Exchange Server 307 with each of Administrator Computer 301, Potential Seller Computer 303, Potential Purchaser Computer 305, and USPTO Website 311 via the Internet 309 is well known to those of ordinary skill in the art and shall not be discussed further.

It is noted that each of Administrator Computer 301, Potential Seller Computer 303, and Potential Purchaser Computer 305 has installed thereon a Web Browser (not shown) and/or an E-mail client program (not shown) for communication with Secure Information Exchange Server 307 via the Internet 309 in a manner well known to those of ordinary skill in the art.

Turning now to a more detailed discussion of Secure Information Exchange Server 307, it is seen that Secure Information Exchange Server 307 includes Internet Interface 313 for carrying out communication between Secure Information Exchange Server 307 and: i) Administrator Computer 301, ii) Potential Seller Computer 303, iii) Potential Purchaser Computer 305, and iv) USPTO Website 311. Secure Information Exchange Server 307 also includes CPU 315 for performing calculations, transferring data, and orchestrating the operation of the other elements of Secure Information Exchange Server 307.

In addition, Secure Information Exchange Server 307 includes the following elements:

a) Patent Under Test (“PUT”) Identifier Database 317 for storing data identifying patent(s), the validity of which a Potential Purchaser 306 is seeking to determine, wherein the data identifying the patent(s) is input from the Potential Purchaser Computer 305, received by the Internet Interface 313, and passed from CPU 315 into the PUT Identifier Database 317;

b) Patent Under Test (“PUT”) Text/Image Retrieval Module 319 for retrieving, from the USPTO Website 311, text and/or images corresponding to each of the patent(s) identified by the data stored in the PUT Identifier Database, wherein the text and/or images are retrieved by directing the Database Search Engine 311a of the USPTO Website 311 to return, from the Patent Database 311b, the desired text and/or images;

c) Patent Under Test (“PUT”) Text/Image Database 321 for storing therein text and/or images retrieved by the PUT Text/Image Retrieval Module;

d) Seller Submitted Documents—Original Version Text/Image Database 323 for storing therein text and/or images corresponding to Original Version Document(s) submitted electronically by Potential Seller 304, wherein the submission(s) are input from Potential Seller Computer 303, received by the Internet Interface 313, and passed from CPU 315 into the Seller Submitted Documents—Original Version Text/Image Database 323;

e) Original Version Document To New Version Document Conversion Module 325 for converting each Original Version Document stored in the Seller Submitted Documents—Original Version Text/Image Database 323 into a New Version Document containing at least part of the subject matter of the Original Version Document but not containing bibliographic data, that is, source-identifying data;

f) Seller Submitted Documents—New Version Text/Image Database 327 for storing therein the New Version Document(s) generated by the Original Version Document To New Version Document Conversion Module;

g) Seller Submitted Documents—Original Version Bibliographic Data Database 329 for storing therein bibliographic data (i.e., source-identifying data) corresponding to each of the Original Versions Document(s) submitted electronically by Potential Seller 304, wherein the bibliographic data is input from Potential Seller Computer 303, received by the Internet Interface 313, and passed from CPU 315 into the Seller Submitted Documents—Original Version Bibliographic Data Database 329;

h) E-mail Module 331 for communicating with Potential Purchaser Computer 305 to indicate when a new Seller Submitted Document corresponding to a Patent Under Test input by Potential Purchaser 306 has been received and accepted by Secure Information Exchange Server 307 and for communicating with Potential Seller Computer 303 to indicate when Potential Purchaser 306 has chosen to purchase bibliographic data corresponding to an Original Version Document submitted by Potential Seller 304 and/or a copy of an Original Version Document submitted by Potential Seller 304;

i) Rule-based Cutoff Date Calculation Module 333 for calculating one or more Cutoff Date(s) before which a document must have been published (or in the case of a patent issued or effectively filed) to be applied as prior art against a patent in the PUT Identifier Database 321 under a given Law and/or Regulation;

j) Cutoff Date Database 335 for storing therein Cutoff Date(s) corresponding to each patent in the PUT Identifier Database 321, wherein the Cutoff Date(s) are provided to the Cutoff Date Database 335 from the Rule-based Cutoff Date Calculation Module 333;

k) References Cited Data Extraction Module 337 for extracting from the data stored in the PUT Text/Image Database 321 data identifying each of the references cited in each of the patents stored in the PUT Text/Image Database 321;

l) References Cited Database 339 for storing therein data identifying each of the references cited in each of the patents stored in the PUT Text/Image Database 321; wherein the data identifying each of the references cited in each of the patents stored in the PUT Text/Image Database 321 is provided from the References Cited Data Extraction Module 337;

m) Data Comparison Module 349 for:

I) examining:

a) the Original Version Document(s) corresponding to a given Patent Under Test stored in the Seller Submitted Documents—Original Version Text/Image Database 323; and/or

b) the bibliographic data corresponding to a given Patent Under Test stored in the Seller Submitted Documents—Original Version Bibliographic Data Database 329; and/or

c) the data stored in the Cutoff Date Database 335 corresponding to a given Patent Under Test; and/or

d) the references cited in the References Cited Database 339 corresponding to the a given Patent Under Test; and

II) determining:

a) if a new Seller Submitted Document was cited in a corresponding Patent Under Test (as indicated by the data stored in the References Cited Database 339; and

b) if a new Seller Submitted Document was published, or in the case of a patent, issued or effectively filed, after a Cutoff Date corresponding to the Patent Under Test (as indicated by the data stored in the Cutoff Date Database 335 and/or the Seller Submitted Documents—Original Version Text/Image Database 323 and/or the Seller Submitted Documents—Original Version Bibliographic Data Database 329); and

c) if a new Seller Submitted Document has been submitted by another Potential Seller (as indicated in the Seller Submitted Documents Original version Text/Image Database 323 and/or the Seller Submitted Documents—Original Version Bibliographic Data Database 329); and

n) Payment Module 341 for receiving payment from Potential Purchaser 306 (preferably in the form of a secure credit card authorization, a secure debit card transfer, or another form of secure electronic payment from Potential Purchaser Computer 305);

o) Document Value Database 336 for storing data identifying:

I) a purchase price which Potential Purchaser 306 will pay for bibliographic data and/or Original Version Documents having a bearing on the validity of a Patent Under Test, wherein the data identifying the purchase price is input from Potential Purchaser Computer 305, received by Internet Interface 313, and passed from CPU 315 into Document Value Database 336; and/or

II) a sale price which Potential Seller 304 will accept for bibliographic data and/or Original Version Documents having a bearing on the validity of a Patent Under Test, wherein the data identifying the sale price is input from Potential Seller Computer 305, received by Internet Interface 313, and passed from CPU 315 into Document Value Database 336;

p) Claim To Drawing Cross-reference Module 350 for generating cross-reference data between the claims of a Patent Under Test (such claims of the Patent Under Test being available in the PUT Text/Image Database 321) and the drawings of a Patent Under Test (such drawings of the Patent Under Test being available in the PUT Text/Image Database 321);

q) Claim To Drawing Cross-reference Database 352 for storing therein cross-reference data corresponding to each Patent Under Test, wherein the cross-reference data is provided from Claim To Drawing Cross-reference Module 350; and

r) Display Engine 343 for:

I) generating and maintaining one or more Potential Seller Web Pages for review by Potential Seller 304, wherein the Potential Seller Web Page(s):

a) identify each Patent Under Test stored in PUT Identifier Database 317; and/or

b) contain substantive content corresponding to each Patent Under Test obtained from PUT Text/Image Database 321; and/or

c) identify the Cutoff Date(s) corresponding to each Patent Under Test stored in PUT Identifier Database 317; and/or

d) identify each reference stored in References Cited Database 339 corresponding to each Patent Under Test; and/or

e) identify the purchase price for documents corresponding to each Patent Under Test stored in Document Value Database 336; and/or

f) contain, for each Patent Under Test, cross-reference data between the claim elements of each Patent Under Test and the drawing elements of each Patent Under Test, wherein the cross-reference data for each Patent Under Test is stored in Claim To Drawing Cross-reference Database 352 (such cross-reference data is provided as an aid in helping people unfamiliar with a patent's format to determine what is claimed by the patent and such cross-reference data is preferably graphic in nature (i.e., the drawing elements are graphically linked to the corresponding claim elements) and

II) generating and maintaining one or more Potential Purchaser Web Pages for review by Potential Purchaser 306, wherein the Potential Purchaser Web Page(s):

a) contain substantive content corresponding to each New Version Document obtained from the Seller Submitted Documents—New Version Text/Image Database 327; and/or

b) identify the sale price for each Seller Submitted Document stored in Document Value Database 336; and

III) generating and maintaining one or more Actual Purchaser Web Pages for review by Potential Purchaser 306 (after Potential Purchaser 306 has become an Actual Purchaser), wherein the Actual Purchaser Web Pages contain:

a) substantive content corresponding to each purchased Original Version Document (the Original Version Documents are obtained from Seller Submitted Documents—Original Version Text/Image Database 323); and/or

b) each piece of purchased bibliographic data (the bibliographic data is obtained from the Seller Submitted Documents—Original Version Bibliographic Data Database 329).

With reference to Original Version To New Version Conversion Module 325 it is noted that this module may operate in one of two modes. In an “automatic mode” it operates on Original Version Documents in standard formats with readily identifiable fields. Such readily identifiable fields may be parsed using procedures well known to those of ordinary skill in the art to identify bibliographic data. Such bibliographic data is then redacted from the New Version Document when it is generated. In contrast, Original Version To New Version Conversion Module 325 operates in “manual mode” when the Original Version Document is in “free-form format” without readily identifiable fields which may easily be parsed. In this “manual mode” the Administrator 302 manually instructs Original Version To New Version Conversion Module 325 which portions of the Original Version Document to redact when generating the New Version Document.

With reference to Claim To Drawing Cross-reference Module 350 it is noted that this module may also operate in one of two modes. In an “automatic mode” it operates on Patent Under Test claims and drawings containing inherent cross reference data between the claim elements and the drawing elements, such as found in many foreign patent applications wherein each claim element contains an explicit numerical reference to a corresponding drawing element. In such cases Claim To Drawing Cross-reference Module 350 can readily cross-reference the claim elements with the drawing elements. In contrast, Claim To Drawing Cross-reference Module 350 operates in “manual mode” when the claims of the Patent Under Test do not contain such inherent cross-reference data. In this “manual mode” the Administrator 302 manually instructs Claims To Drawing Cross-reference Module 350 which claim elements relate to which drawing elements.

With reference to Rule-based Cutoff Date Calculation Module 333 it is noted that one rule which is preferably utilized is that a Cutoff Date shall represent the latest date that a document could have been published, and/or effectively filed (if a patent), and/or issued (if a patent) in order to be applied as prior art against the Patent Under Test pursuant to Sections 102 and 103 of Title 35 of the United States Code (“35 USC 102” and 35 USC 103”, respectively, the text of each of which is incorporated herein by reference).

Finally, it is noted that FIG. 3 shows Administrator/Potential Seller Communication Channel 345 and Administrator/Potential Purchaser Communication Channel 347. Administrator/Potential Seller Communication Channel 345 is used when electronic communication via the Internet 309 between Administrator 302 and Potential Seller 304 is not practical or desirable. For example, if Potential Seller 304 desires to submit to the Secure Information Exchange Server 307 a Seller Submitted Document that is not in electronic format then Potential Seller 304 can use Administrator/Potential Seller Communication Channel 345 to provide Administrator 302 a hard-copy of the Seller Submitted Document (via mail, FAX, or courier service, for example). Administrator 302 may then convert the Seller Submitted Document into an electronic text-based and/or image-based document (by scanning or other suitable means well known to those of ordinary skill in the art) and submit it (along with appropriate bibliographic data) to Secure Information Exchange Server 307 where the document and bibliographic data are then treated as if submitted by Potential Seller 304. In another alternative, Administrator 302 may convert the hard-copy of the Seller Submitted Document into an electronic text-based and/or image-based document (by scanning or other suitable means well known to those of ordinary skill in the art), generate a New Version Document without bibliographic data, and submit both documents (along with appropriate bibliographic data) to Secure Information Exchange Server 307 where the documents and bibliographic data will then be treated as if submitted by Potential Seller 304. Likewise, Administrator/Potential Purchaser Communication Channel 347 may be utilized to provide Potential Purchaser 306 with a hard-copy of the New Version Document (before purchase) and/or a copy of the Original Version Document (after purchase).

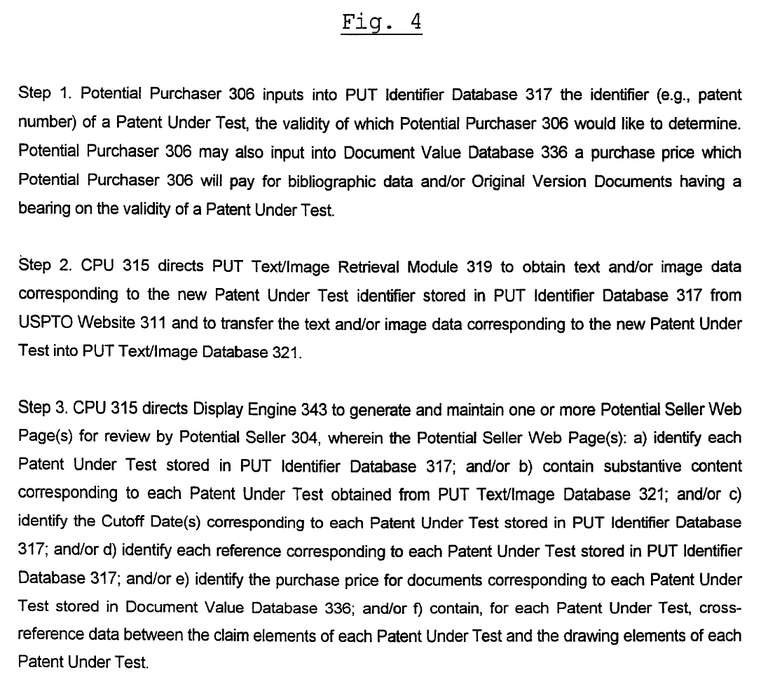

Referring now to FIG. 4, a flowchart showing part of the operation of the embodiment of FIG. 3 is shown. More particularly, this FIG. 4 shows the operation of the embodiment of FIG. 3 with regard to receiving identification of a Patent Under Test from Potential Purchaser 306 and generating one or more Potential Seller Web Pages containing data corresponding to one or more Patents Under Test.

In any case, as seen in this FIG. 4, at Step 1 Potential Purchaser 306 inputs into PUT Identifier Database 317 the identifier (e.g., patent number) of a Patent Under Test, the validity of which Potential Purchaser 306 would like to determine. Potential Purchaser 306 may also input into Document Value Database 336 a purchase price which Potential Purchaser 306 will pay for bibliographic data and/or Original Version Documents having a bearing on the validity of a Patent Under Test. The identifier of the Patent Under Test is input into PUT Database 317 via Potential Purchaser Computer 305, Internet 309, Internet Interface 313, and CPU 315. The purchase price is input into Document Value Database 336 via Potential Purchaser Computer 305, Internet 309, Internet Interface 313, and CPU 315.

At Step 2 of FIG. 4 CPU 315 directs PUT Text/Image Retrieval Module 319 to obtain text and/or image data corresponding to the new Patent Under Test identifier stored in PUT Identifier Database 317 from USPTO Website 311 (by directing Database Search Engine 311a to return the text and/or image data from Patent Database 311b) and to transfer the text and/or image data corresponding to the new Patent Under Test into PUT Text/Image Database 321.

At Step 3 of FIG. 4 CPU 315 directs Display Engine 343 to generate and maintain one or more Potential Seller Web Page(s) for review by Potential Seller 304, wherein the Potential Seller Web Page(s):

a) identify each Patent Under Test stored in PUT Identifier Database 317; and/or

b) contain substantive content corresponding to each Patent Under Test obtained from PUT Text/Image Database 321; and/or

c) identify the Cutoff Date(s) corresponding to each Patent Under Test stored in PUT Identifier Database 317 (wherein the Cutoff Date(s) are stored in Cutoff Date Database 335); and/or

d) identify each reference corresponding to each Patent Under Test stored in PUT Identifier Database 317 (wherein the identification of each reference is stored in References Cited Database 339); and/or

e) identify the purchase price for documents corresponding to each Patent Under Test stored in Document Value Database 336;

and/or

f) contain, for each Patent Under Test, cross-reference data between the claim elements of each Patent Under Test and the drawing elements of each Patent Under Test, wherein the cross-reference data for each Patent Under Test is stored in Claim To Drawing Cross-reference Database 352 (such cross-reference data is provided as an aid in helping people unfamiliar with a patent's format to determine what is claimed by the patent and such cross-reference data is preferably graphic in nature (i.e., the drawing elements are graphically linked to the corresponding claim elements)).

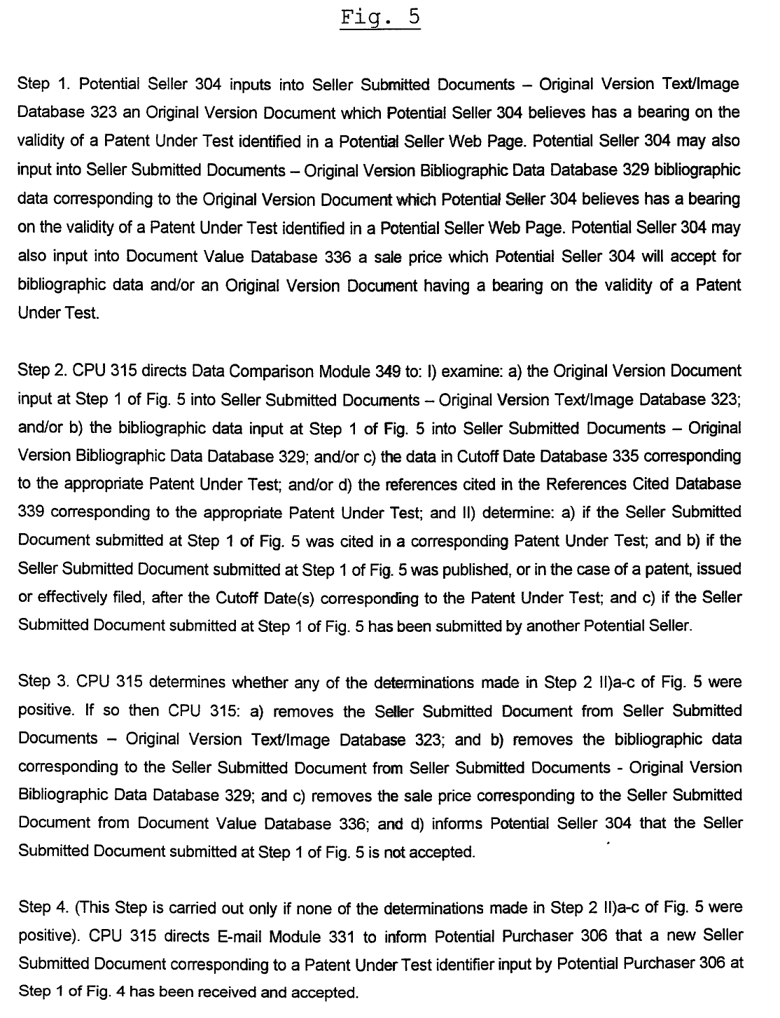

Referring now to FIG. 5, a flowchart showing another part of the operation of the embodiment of FIG. 3 is shown. More particularly, this FIG. 5 shows the operation of the embodiment of FIG. 3 with regard to receiving and accepting a Seller Submitted Document from Potential Seller 304 who has reviewed the Potential Seller Web Page(s) generated at Step 3 of FIG. 4.

In any case, as seen in this FIG. 5, at Step 1 Potential Seller 304 inputs into Seller Submitted Documents—Original Version Text/Image Database 323 an Original Version Document which Potential Seller 304 believes has a bearing on the validity of a Patent Under Test identified in a Potential Seller Web Page. Potential Seller 304 may also input into Seller Submitted Documents—Original Version Bibliographic Data Database 329 bibliographic data corresponding to the Original Version Document which Potential Seller 304 believes has a bearing on the validity of a Patent Under Test identified in a Potential Seller Web Page. Potential Seller 304 may also input into Document Value Database 336 a sale price which Potential Seller 304 will accept for bibliographic data and/or an Original Version Document having a bearing on the validity of a Patent Under Test. The Original Version Document is input into Seller Submitted Documents—Original Version Text/Image Database 323 via Potential Seller Computer 303, Internet 309, Internet Interface 313, and CPU 315. Likewise, the bibliographic data is input into Seller Submitted Documents—Original Version Bibliographic Data Database 329 via Potential Seller Computer 303, Internet 309, Internet Interface 313, and CPU 315 and the sale price is input into Document Value Database 336 via Potential Seller Computer 303, Internet 309, Internet Interface 313, and CPU 315.

At Step 2 of FIG. 5 CPU 315 directs Data Comparison Module 349 to:

I) examine:

a) the Original Version Document input at Step 1 of FIG. 5 into Seller Submitted Documents—Original Version Text/Image Database 323; and/or

b) the bibliographic data input at Step 1 of FIG. 5 into Seller Submitted Documents—Original Version Bibliographic Data Database 329; and/or

c) the data in Cutoff Date Database 335 corresponding to the appropriate Patent Under Test; and/or

d) the references cited in the References Cited Database 339 corresponding to the appropriate Patent Under Test; and

II) determine:

a) if the Seller Submitted Document submitted at Step 1 of FIG. 5 was cited in a corresponding Patent Under Test (as indicated by the data stored in the References Cited Database 339; and

b) if the Seller Submitted Document submitted at Step 1 of FIG. 5 was published, or in the case of a patent, issued or effectively filed, after the Cutoff Date(s) corresponding to the Patent Under Test (as indicated by the data stored in Cutoff Date Database 335 and/or Seller Submitted Documents—Original Version Text/Image Database 323 and/or Seller Submitted Documents—Original Version Bibliographic Data Database 329); and

c) if the Seller Submitted Document submitted at Step 1 of FIG. 5 has been submitted by another Potential Seller (as indicated in Seller Submitted Documents—Original Version Text/Image Database 323 and/or Seller Submitted Documents—Original Version Bibliographic Data Database 329).

At Step 3 of FIG. 5 CPU 315 determines whether any of the determinations made in Step 2 II)a-c of FIG. 5 were positive. If so then CPU 315:

a) removes the Seller Submitted Document from Seller Submitted Documents—Original Version Text/Image Database 323; and

b) removes the bibliographic data corresponding to the Seller Submitted Document from Seller Submitted Documents—Original Version Bibliographic Data Database 329; and

c) removes the sale price corresponding to the Seller Submitted Document from Document Value Database 336; and

d) informs Potential Seller 304 that the Seller Submitted Document submitted at Step 1 of FIG. 5 is not accepted. Potential Seller 304 may preferably be informed why the Seller Submitted Document has not been accepted (i.e., it is one of the references cited in the Patent Under Test, or it has already been submitted, or it does not meet the Cutoff Date requirements, for example). Potential Seller 304 may be informed via a Potential Seller Web Page provided by Display Engine 343, via e-mail provided by E-mail module 341, or by any other suitable means).

At Step 4 of FIG. 5, which is carried out only if none of the determinations made in Step 2 II)a-c of FIG. 5 were positive, CPU 315 directs E-mail Module 331 to inform Potential Purchaser 306 that a new Seller Submitted Document corresponding to a Patent Under Test identifier input by Potential Purchaser 306 at Step 1 of FIG. 4 has been received and accepted.

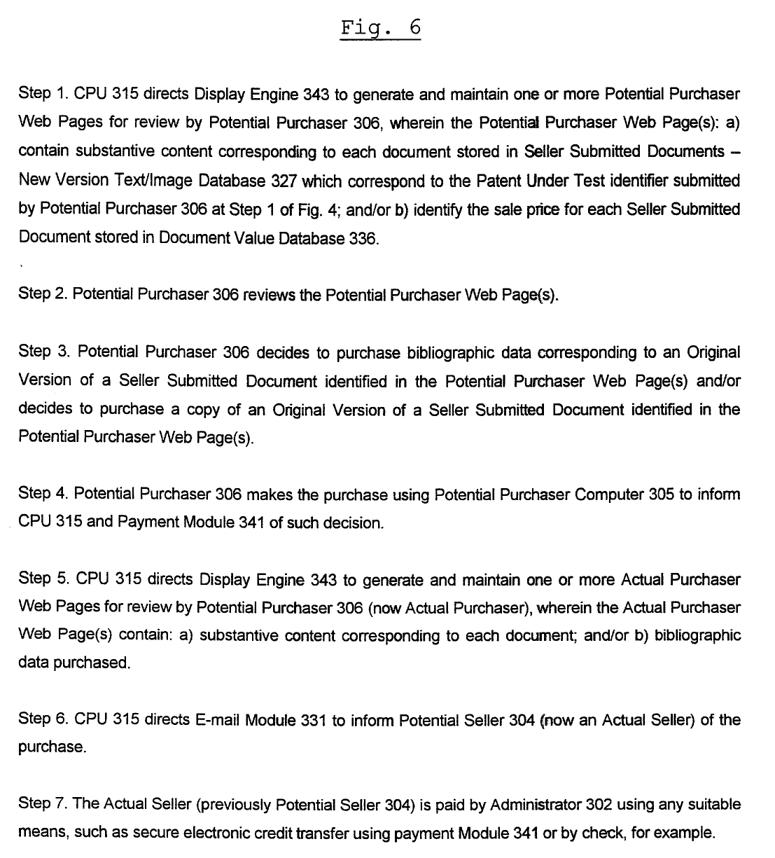

Referring now to FIG. 6, a flowchart showing another part of the operation of the embodiment of FIG. 3 is shown. More particularly, this FIG. 6 shows the operation of the embodiment of FIG. 3 with regard to generating one or more Potential Purchaser Web Pages, processing a purchase request from Potential Purchaser 305, and generating one or more Actual Purchaser Web Pages.

In any case, as seen in this FIG. 6, at Step 1 CPU 315 directs Display Engine 343 to generate and maintain one or more Potential Purchaser Web Pages for review by Potential Purchaser 306, wherein the Potential Purchaser Web Page(s):

a) contain substantive content corresponding to each document stored in Seller Submitted Documents—New Version Text/Image Database 327 which correspond to the Patent Under Test identifier submitted by Potential Purchaser 306 at Step 1 of FIG. 4; and/or

b) identify the sale price for each Seller Submitted Document stored in Document Value Database 336.

At Step 2 of FIG. 6 Potential Purchaser 306 reviews the Potential Purchaser Web Page(s).

At Step 3 of FIG. 6 Potential Purchaser 306 decides to purchase bibliographic data corresponding to an Original Version of a Seller Submitted Document identified in the Potential Purchaser Web Page(s) and/or decides to purchase a copy of an Original Version of a Seller Submitted Document identified in the Potential Purchaser Web Page(s).

At Step 4 of FIG. 6 Potential Purchaser 306 makes the purchase using Potential Purchaser Computer 305 to inform CPU 315 and Payment Module 341 of such decision. Payment Module 341 preferably carries out the transaction electronically and securely in the form of a credit card authorization, a debit card transfer, or another form of electronic payment. In the alternative, other payment methods such as a check sent by mail or courier may be utilized.

At Step 5 of FIG. 6 (after payment) CPU 315 directs Display Engine 343 to generate and maintain one or more Actual Purchaser Web Pages for review by Potential Purchaser 306 (now Actual Purchaser), wherein the Actual Purchaser Web Page(s) contain:

a) substantive content corresponding to each document purchased (the substantive content is available from Seller Submitted Documents—Original Version Text/Image Database 323 and such substantive content may be reviewed and/or downloaded by the Actual Purchaser); and/or

b) bibliographic data purchased (the bibliographic data is available from Seller Submitted Documents—Original Version Bibliographic Data Database 329 and such bibliographic data may be reviewed and/or downloaded by the Actual Purchaser).

At Step 6 of FIG. 6 CPU 315 directs E-mail Module 331 to inform Potential Seller 304 (now an Actual Seller) of the purchase.

At Step 7 of FIG. 6 the Actual Seller (previously Potential Seller 304) is paid by Administrator 302 using any suitable means, such as secure electronic credit transfer using payment Module 341 or by check, for example.

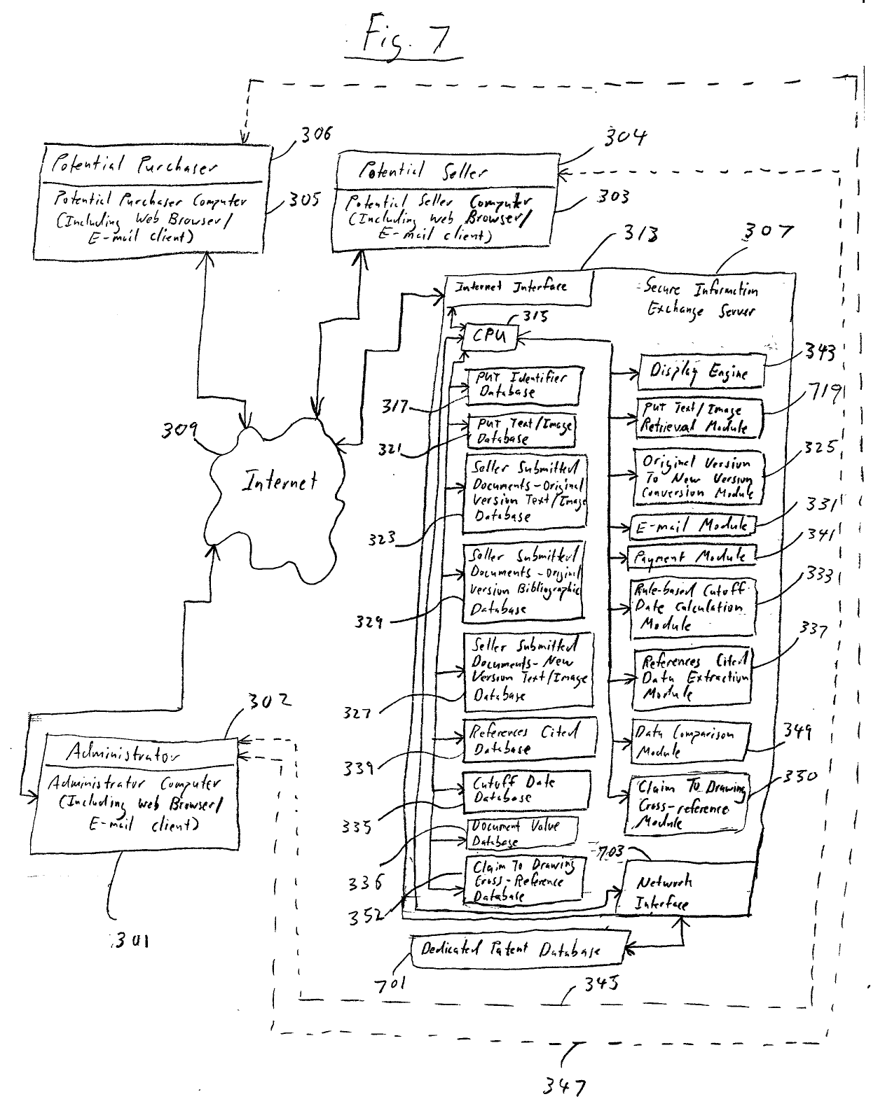

Referring now to FIG. 7, a block diagram of a second embodiment of the instant invention is shown. This second embodiment is similar to the first embodiment with the exception that: a) the USPTO Database Search Engine and Patent Database included in the USPTO Website have been replaced by a Dedicated Patent Database 701; and b) PUT Text/Image Retrieval Module 319 has been replaced by PUT Text/Image Retrieval Module 719, which is adapted to retrieve text and/or images from Dedicated Patent Database 701, rather than from the USPTO Website. In any case, it is noted that Dedicated Patent Database 701 may be made available to Secure Information Exchange Server 307 via Network Interface 703, using any appropriate network methodology, such as a Local Area Network (“LAN”), a Wide Area Network (“WAN”), an extranet, or an intranet, for example. Alternatively, Dedicated Patent Database 701 may be integrated directly into Secure Information Exchange Server 307. Dedicated Patent Database 701 may comprise one or more magnetic, and/or optical, and/or magnetic-optical, and/or solid-state storage means, for example.

Since the other elements of FIG. 7 are substantially identical to the corresponding elements of FIG. 3, they will not be discussed here again. In addition, it is noted that the operation of this second embodiment is substantially identical to the operation of the first embodiment shown in FIGS. 4-6 (as discussed above) with the exception that PUT Text/Image Retrieval Module 719 is adapted to retrieve text and/or images from Dedicated Patent Database 701, rather than from the USPTO Website.

While a number of embodiments of the instant invention have been described, it is understood that these embodiments are illustrative only, and not restrictive, and that many modifications may become apparent to those of ordinary skill in the art. For example, while Administrator Computer 301 is described as being connected to Secure Information Exchange Server 307 via Internet Connection 309, Administrator Computer 301 could instead be more directly associated with Secure Information Exchange Server 307 via an intranet, extranet, Local Area Network (“LAN”), or Wide Area Network (“WAN”), for example. Alternatively, Administrator Computer 301 may be integrated into Secure Information Exchange Server 307 or Administrator Computer 301 could be removed and its functions carried out directly by Secure Information Exchange Server 307. Further, while the first embodiment of the instant invention is described as communicating with the USPTO Website to obtain the text and/or image data corresponding to each Patent Under Test it is understood that any other suitable Website or Database, either governmental or otherwise, may of course be used instead (e.g., the European Patent Office Website currently found at “http://european-patent-office.org/” or the IBM Intellectual Property Network Website currently found at “http: //www.patents.ibm.com/home”). Further still, the Display Engine as well as each of the Modules included in the Secure Information Exchange Server could be embodied in hardware, software, firmware, or any combination thereof. Further still, the Display Engine as well as each of the Modules included in the Secure Information Exchange Server could be embodied in larger units containing the functionality of one or more of the Display Engine and/or Modules. Further still, each of the Databases included in the Secure Information Exchange Server could be comprised of hardware, software, firmware, or any combination thereof. Further still, each of the Databases included in the Secure Information Exchange Server could be embodied in larger units containing the functionality of one or more of the Databases. Further still, while the first and second embodiments discuss providing the Actual Purchaser the purchased bibliographic data and/or purchased copy of the Original Version of the Seller Submitted Document via review or download from one or more Actual Purchaser Web Page(s), the purchased bibliographic data and/or purchased copy of the Original Version of the Seller Submitted Document could, of course, be provided to the Actual Purchaser through any other suitable means, such as FTP download, or hard-copy delivery via FAX, mail, or courier, for example. Further still, while the embodiments described herein mentioned the text of 35 USC 102 and 35 USC 103 as “rules” used by the Rule-based Cutoff Date Calculation Module it is understood that any desired laws or regulations may be used (i.e., different or subsequent patent laws or regulations of the United States of America and/or patent laws or regulations of other countries besides the United States of America). Further still, it is noted that some of the operational steps carried out by the instant invention may be carried out in a different order (and/or in a recursive form) from that described herein to achieve substantially the same result. Further still, while the instant invention has been described principally with respect to communication via the Internet, other networking methodologies may, of course, be employed (such as a Local Area Network (“LAN”), a Wide Area Network (“WAN”), an intranet, or an extranet, for example). Further still, it is noted that the Secure Information Exchange Server can be operated in a manner which provides controlled access to one or more of its features (i.e., the features of the Secure Information Exchange Server may be accessible on a pay-per-use basis, on a subscription basis, or on a registration basis, for example).

What is claimed is:

1. A method for permitting a potential purchaser to review at least part of the subject matter of a document without being informed of the document's bibliographic data and for assuring payment to a seller if the potential purchaser chooses to purchase at least one of the document's bibliographic data and an original version of the document, comprising:
receiving from the potential seller at least one of the document's bibliographic data and an original version of the document;
obtaining an original version of the document if not received from the potential seller;
generating a new version of the document which does not contain the document's bibliographic data and which does contain at least part of the subject matter of the original version of the document;
providing the new version of the document to the potential purchaser;
obtaining from the potential purchaser an obligation to pay a purchase price if the potential purchaser chooses to purchase at least one of the document's bibliographic data and an original version of the document; and
providing at least one of the document's bibliographic data and an original version of the document to the potential purchaser if the potential purchaser chooses to purchase at least one of the document's bibliographic data and an original version of the document.

2. The method of claim 1, wherein the step of providing the new version of the document to the potential purchaser further comprises providing the new version of the document to the potential purchaser in electronic form.

3. The method of claim 2, wherein the step of providing the new version of the document to the potential purchaser in electronic form further comprises providing the new version of the document to the potential purchaser via an internet web page.

4. The method of claim 1, wherein the step of providing at least one of the document's bibliographic data and an original version of the document to the potential purchaser if the potential purchaser chooses to purchase at least one of the document's bibliographic data and an original version of the document further comprises providing at least one of the document's bibliographic data and an original version of the document to the potential purchaser in electronic form.

5. The method of claim 5, wherein the step of providing at least one of the document's bibliographic data and an original version of the document to the potential purchaser in electronic form further comprises providing at least one of the document's bibliographic data and an original version of the document to the potential purchaser via an internet web page.

6. The method of claim 1, further comprising carrying out a purchase transaction electronically and securely using a protocol selected from the group comprising: a) a credit card authorization, b) a debit card transfer, and c) another form of electronic payment.

7. A method for permitting a potential purchaser to review at least part of the subject matter of a document which potentially has a bearing on a patent under test without being informed of the document's bibliographic data and for assuring payment to a seller if the potential purchaser chooses to purchase at least one of the document's bibliographic data and an original version of the document, comprising:
providing to the potential seller data identifying the patent under test;
receiving from the potential seller at least one of the document's bibliographic data and an original version of the document;
obtaining an original version of the document if not received from the potential seller;
generating a new version of the document which does not contain the document's bibliographic data and which does contain at least part of the subject matter of the document;
providing the new version of the document to the potential purchaser;
obtaining from the potential purchaser an obligation to pay a purchase price if the purchaser chooses to purchase at least one of the document's bibliographic data and an original version of the document; and
providing at least one of the document's bibliographic data and an original version of the document to the potential purchaser if the potential purchaser chooses to purchase at least one of the document's bibliographic data and an original version of the document.

8. The method of claim 7, wherein the step of providing the new version of the document to the potential purchaser further comprises providing the new version of the document to the potential purchaser in electronic form.

9. The method of claim 8, wherein the step of providing the new version of the document to the potential purchaser in electronic form further comprises providing the new version of the document to the potential purchaser via an internet web page.

10. The method of claim 7, wherein the step of providing at least one of the document's bibliographic data and an original version of the document to the potential purchaser if the potential purchaser chooses to purchase at least one of the document's bibliographic data and an original version of the document further comprises providing at least one of the document's bibliographic data and an original version of the document to the potential purchaser in electronic form.

11. The method of claim 10, wherein the step of providing at least one of the document's bibliographic data and an original version of the document to the potential purchaser in electronic form further comprises providing at least one of the document's bibliographic data and an original version of the document to the potential purchaser via an internet web page.

12. The method of claim 7, wherein the step of providing to the potential seller data identifying the patent under test further comprises providing to the potential seller data in an electronic format identifying the patent under test.

13. The method of claim 12, wherein the step of providing to the potential seller data in an electronic format identifying the patent under test further comprises providing to the potential seller data via an internet web page identifying the patent under test.

14. The method of claim 7, further comprising providing to the potential seller data identifying a date by which a document must have been published, or in the case of a patent issued or effectively filed, in order to be applied against the patent under test as prior art.

15. The method of claim 14, wherein the step of providing to the potential seller data identifying a date by which a document must have been published, or in the case of a patent issued or effectively filed, in order to be applied against the patent under test as prior art further comprises providing to the potential seller data in an electronic form identifying a date by which a document must have been published, or in the case of a patent issued or effectively filed, in order to be applied against the patent under test as prior art.

16. The method of claim 15, wherein the step of providing to the potential seller data in an electronic form identifying a date by which a document must have been published, or in the case of a patent issued or effectively filed, in order to be applied against the patent under test as prior art further comprises providing to the potential seller data via an internet web page identifying a date by which a document must have been published, or in the case of a patent issued or effectively filed, in order to be applied against the patent under test as prior art.

17. The method of claim 7, further comprising the step of providing to the potential purchaser data selected from the group consisting of (a) a date before which the document was published; (b) a country in which the document was published; and (c) the type of publication in which the document was published.

18. The method of claim 17, wherein the step of providing to the potential purchaser data selected from the group consisting of (a) a date before which the document was published; (b) a country in which the document was published; and (c) the type of publication in which the document was published further comprises providing to the potential purchaser data in an electronic form selected from the group consisting of (a) a date before which the document was published; (b) a country in which the document was published; and (c) the type of publication in which the document was published.

19. The method of claim 18, wherein the step of providing to the potential purchaser data in an electronic form selected from the group consisting of (a) a date before which the document was published; (b) a country in which the document was published; and (c) the type of publication in which the document was published further comprises providing to the potential purchaser data via a web page on the internet selected from the group consisting of (a) a date before which the document was published; (b) a country in which the document was published; and (c) the type of publication in which the document was published.

20. The method of claim 7, further comprising carrying out a purchase transaction electronically and securely using a protocol selected from the group comprising: a) a credit card authorization, b) a debit card transfer, and c) another form of electronic payment.
